(19) United States
(12) Patent Application Publication
(10) Pub. No.: US 2001/0053227 A1
(43) Pub. Date: Dec. 20, 2001

(54) Automatic mono/stereo detection

(76) Inventor: Veerava Narasimhan, Yishun (SG)

Correspondence Address: Michael E. Marion, U.S. Philips Corporation, 580 White Plains Road, Tarrytown, NY, 10591, US

(21) Appl. No.: 09/833,427

(22) Filed: Apr. 12, 2001

(30) Foreign Application Priority Data
Apr. 14, 2000 (SG) 0002144-4

(51) Int. Cl. H04H 5/00

(52) U.S. Cl. 381/11; 381/12; 381/123

(57) ABSTRACT

Audio-processing devices are known generally. When such an audio device wants to use as input signals from another device de audio device has to determine whether the received input signals are mono signals or stereo signals.

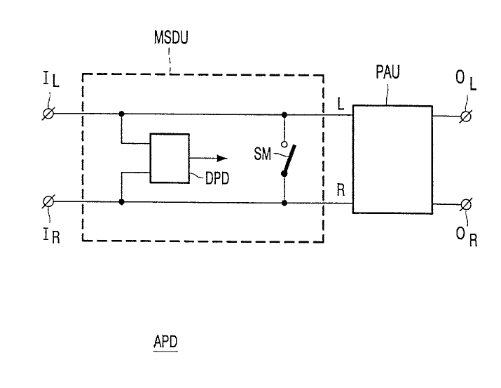

Known audio devices use input sockets which detect whether a stereo or a mono connector is used and on the basis hereof switches the processing between stereo and mono.

The device according to the invention detects electronically whether stereo or mono input signals are received.

The invention relates to an audio-processing device as described in the preamble of claim 1.

The invention further relates to an audio receiver comprising such an audio-processing device.

The invention further relates to a television receiver comprising such an audio-processing device.

An audio processing device comprising a mono/stereo detection unit is known from the U.S. Pat. No. 5,655,025. Herein a mono/stereo detection unit is described which detects that a mono connector is inserted into a stereo jack. Thus insertion of a mono connector is detected by the mono/stereo detection unit. So this mono/stereo detection unit recognizes the type of inserted connector.

For example in television receivers with stereo sound with one or more external audio inputs, such as AV1, AV2, . . . . Side AV Front AV, etc. each consisting of a Left (L) and a Right (R) channel in order to reproduce external input sound through loudspeakers of the television receiver. This works well with external audio sources that are stereo. For mono input with a single input (mono recorders, mono receivers) extra security is needed to reproduce the sound at both loudspeakers. For example using cinch sockets with a switch, it is possible to give output through both loudspeakers and only one channel input is present. Normally a switch is mounted with the right cinch socket is used. In that case it is necessary that the mono input is fed to the left input to be heard on both loudspeakers. To be able to handle the mono input signal in the processing and amplifying unit the left input is used and at the right input of the processing and amplifying unit this signal is fed through the switch. This known mono/stereo detection unit only operates without failure when the stereo/mono jack operates mechanically without a failure.

It is an object of the invention to provide an audio-processing device with a mono/stereo detection unit, which uses an electronic circuit to detect the type of input and automatically handle the switching function. To this end an audio-processing device according to the invention is characterized by the features of claim 1.

The audio processing device with the mono/stereo detection unit according to the invention is much more accurate and fail safe than the known device. Further this audio processing device operates independently of the kind of inputs the device has and is not as the known device is dependent on the kind of connectors used. The mono/stereo detection unit according to the invention detects electronically whether a stereo signal is received (so both inputs are used) or a mono signal is received so one of the inputs is used. In case of a mono input signal this device is not dependent on, on which input the mono signal is supplied.

Embodiments of the invention will be described in the dependent claims.

The invention and additional features, which may optionally be used to implement the invention to advantage, will be apparent from and elucidated with reference to the examples described below and hereinafter and shown in the figure.

The figure shows a schematic embodiment of an audio-processing device according to the invention.

The figure shows an audio-processing device APD comprising a first input IL and a second input IR. On these inputs either a stereo audio signal can be received or at one of the inputs a mono input signal can be received.

The inputs of the audio-processing device are coupled to a mono/stereo detection unit MSDU comprising in this example a quasi peak detector QPD and switching means SM. The outputs of the mono/stereo detection unit are coupled to a processing and amplifying unit PAU which unit processes and amplifies the received signals and supplies the signals to a first output OL and a second output OR.

The operation of the mono/stereo detection unit according to the invention is as follows. In case stereo signals are received on the inputs IL and IR the quasi peak detector QPD supplies a control signal to the switching means SM to keep the switching means in open position. In case a mono signal is received on one of the inputs IL or IR the quasi peak detector QPD detects this mono signal and supplies a control signal to the switching means to close the switching means. By closing the switching means the mono input signal received either on input IL or on input IR is supplied to both inputs of the processing and amplifying unit PAU. In this way it is made possible to reproduce the mono input signal always on both outputs OL and OR independent on the input IL or IR on which the mono signal is received.

The man skilled in the art will recognize that the mono/stereo detection unit can be amended without departing from the main idea of the invention concerned.

1. Audio processing device for processing an audio input signal comprising a first and a second input, a processing and amplifying unit, and a mono/stereo detection unit, characterized in that the audio processing device comprises an automatic mono/stereo unit in dependence of the received input signals.

2. Audio processing device as claimed in claim 1 characterized in that the mono/stereo detection unit comprises switching means for coupling the first and second input of the audio processing device after detection of a mono audio input signal and further comprises a quasi peak detector for supplying a control signal to the switching means.

3. Audio receiver comprising an audio-processing device as claimed in claim 1.

4. Television receiver comprising an audio-processing device as claimed in claim 1.

5. Mono/stereo detection unit for use in an audio processing device as claimed in claim 1.
